(19) United States
(12) Patent Application Publication
(10) Pub. No.: US 2010/0274581 A1
(43) Pub. Date: Oct. 28, 2010

(54) ELECTRONIC SYSTEM AND METHOD FOR PROCESSING DRUG PRESCRIPTIONS

(75) Inventors: Gary W. Chin, Toronto (CA); Ambrose C.H. Au, Markham (CA)

Correspondence Address: BERESKIN AND PARR LLP/S.E.N.C.R.L., s.r.l., 40 KING STREET WEST, BOX 401, TORONTO, ON, M5H 3Y2, CA

(73) Assignee: Medisystem Technologies Inc., Toronto (CA)

(21) Appl. No.: 12/830,699

(22) Filed: Jul. 6, 2010

Related U.S. Application Data
(63) Continuation of application No. 11/125,127, filed on May 10, 2005, now abandoned.

(51) Int. Cl. G06Q 50/00; G06F 21/20; G06F 3/048; G06F 17/30; G06F 13/10; G06F 15/16; G06F 3/033; G06F 3/12

(52) U.S. Cl. 705/2; 726/12; 715/771; 707/805; 710/33; 709/217; 345/179; 358/1.15; 707/E17.044

(57) ABSTRACT

Some embodiments of the invention provide an electronically-aided system and method for processing drug prescriptions in a manner that may reduce the number of lost and/or incorrectly filled drug prescriptions without disrupting existing operating procedures within a pharmacy or an inpatient health-care facility. In such embodiments, the potential for human error is reduced by reducing the number of times information is manually processed, handled and/or transcribed by individuals in the health-care staff. By contrast, hand-written notes and instructions provided by a doctor are automatically electronically captured by a digitally-enabled pen, as the doctor writes. The respective electronically captured data can be processed into image files and sent to a pharmacy, thereby significantly reducing the number of times information is manually processed, handled and/or transcribed by individuals in the health-care staff.

### FIELD OF THE INVENTION

The invention relates to medical informatics, and, in particular to electronic systems and methods for processing drug prescriptions.

### BACKGROUND OF THE INVENTION

Each doctor working within an inpatient health-care facility, such as a nursing home or a hospital, routinely updates the respective medical history of each patient the doctor assesses throughout the course of a day. The updates are normally in the form of hand-written notes and may include a new drug prescription and/or warnings (e.g. about drug allergies, dangerous drug combinations for a particular patient and the like). Doctors pass their hand-written notes to nurses to be sorted into corresponding patient files, which are often referred to as charts. During the sorting process the nurses must identify new drug prescriptions, warnings and any other information relevant to a pharmacist, transcribe all such information into prescription orders and then fax the prescription orders to a pharmacy. When the faxes are received at the pharmacy a pharmacist or an assistant sorts and enters the information into a database. The pharmacist reviews the database and fills drug prescriptions accordingly.

It is estimated that there is a 3%-5% error rate associated with the conventional facsimile method of processing drug prescriptions described above. The errors may result in lost and/or incorrectly filled drug prescriptions. Human error, at both the inpatient health-care facility and the pharmacy, is the primary source of error. Human error in a health-care environment is difficult to address, since health-care staff act according to strict operating procedures that are hard to adjust without introducing added liability. Subsequently, the health-care staff are often averse to procedural changes because they often perceive such changes to inherently include increased liability. Additionally, poor-quality and lost fax transmissions are a secondary source of error. However, fax transmission of prescription orders to a pharmacy has traditionally been the only way to verify signatures required for drug dispensing, as electronic signatures are not acceptable for placing prescription orders in all jurisdictions.

### SUMMARY OF THE INVENTION

According to an aspect of an embodiment of the invention there is provided a client network node for drug prescription processing within a health-care facility comprising: a digitally-enabled pen having an ink dispensing system for dispensing ink onto a form, and an optical sensor system for recognizing a digital map pattern on the same form and electronically capturing pen stroke information while the digitally-enabled pen is used to write on the form; a workstation computer having a memory and a processor, the processor having computer readable program code means embodied thereon for (i) producing an image file, from electronically captured pen stroke information and the digital map pattern, corresponding to the form used in the health-care facility; and (ii) transmitting at least one of the image file and the electronically captured pen stroke information; and a means of transferring electronically captured pen stroke information from the digitally-enabled pen into the memory.

In some embodiments the means of transferring electronically captured pen stroke information from the digitally-enabled pen into the memory is a pen-cradle, connectable to the workstation computer, into which the digitally-enabled pen can be placed.

In some embodiments the means of transferring electronically captured pen stroke information from the digitally-enabled pen into the memory includes at least one of a Bluetooth wireless modem, an Ethernet connection and a Universal Serial Bus (USB) connection.

In some embodiments the workstation computer includes computer readable program code means having instructions for: determining if one or more new drug prescriptions are included in the electronically captured pen stroke information; generating a prescription order including the one or more new drug prescriptions; and transmitting the prescription order. In some more specific embodiments the workstation computer also includes computer readable program code means having instructions for printing the prescription order at the health-care facility.

In some embodiments the client network node also includes a Local Area Network (LAN) to which the workstation computer belongs, the LAN including other workstation computers also having respective memory and processors, each respective processor having computer readable program code means embodied thereon for (i) producing an image file, from electronically captured pen stroke information and a digital map pattern; and (ii) transmitting at least one of the image file and the electronically captured pen stroke information.

In some embodiments the client network node also includes a connection to a data network, the data network including a suitable combination of at least one of a portion of a private intranet, the publicly accessible internet, switched telephone lines, Ethernet connections, ISDN lines, optical data-transport links, wireless data links and any suitable combination of the same and similar elements. In some more specific embodiments, the client network node also includes a network firewall gateway connectable between the workstation computer and the data network.

According to an aspect of an embodiment of the invention there is provided a pharmacy network node for processing drug prescription orders received from a health-care facility comprising: a database for storing received drug prescriptions; an order server externally connectable to a data network for electronically receiving a prescription order, the order server includes computer readable program code means having instructions for (i) parsing the prescription order to determine if one or more new drug prescriptions are included in the prescription order; and (ii) entering the one or more new drug prescriptions into database; and a user interface for accessing information on at least one of the order server and database.

In some embodiments the order server also includes computer readable program code means having instructions for recreating image files, from information included within the prescription order, corresponding to respective forms written on at a health-care facility.

In some more specific embodiments the pharmacy network node also includes a Local Area Network (LAN) to which the order server belongs, the LAN also including: a database server for electronically storing the database; a storage server for electronically storing the image files; and a pharmacist station, including the user interface, through which a user can review information on at least one of the order server, the database server and the storage server. In some even more specific embodiments the LAN also includes a technician station, including another user interface, through which a user can review information on at least one of the order server, the database server and the storage server.

In some more specific embodiments the pharmacist station also includes computer readable program code means having instructions for recreating image files, from information included within the prescription order, corresponding to respective forms written on at a health-care facility.

In some more specific embodiments some of the information included within a prescription order is electronically captured pen stroke information and information about a digital map pattern.

In some embodiments the pharmacy network node also includes a connection to a data network, the data network including a suitable combination of at least one of a portion of a private intranet, the publicly accessible internet, switched telephone lines, Ethernet connections, ISDN lines, optical data-transport links, wireless data links and any suitable combination of the same and similar elements. In some more specific embodiments the pharmacy network node also includes a network firewall gateway connectable between the order server and the data network. In some more specific embodiments the order server further comprises a connection to a fax transmission line, the fax-transmission line serving as a fax-based backup to the data network.

According to an aspect of an embodiment of the invention there is provided a drug prescription processing system comprising: at least one client network node including (i) a digitally-enabled pen for writing on a form, for recognizing a digital map pattern on the same form and electronically capturing pen stroke information while the digitally-enabled pen is used to write on the form; and (ii) a workstation computer having computer readable program code means embodied thereon for producing an image file from electronically captured pen stroke information and the digital map pattern; at least one pharmacy network node including an order server for electronically receiving a prescription order, and a user interface for accessing information on the order server; and a central office network node, connectable between each of the at least one client network nodes and each of the at least one pharmacy network nodes, the central office network node having computer readable program code means embodied thereon for (a) sorting prescription orders from each of the at least one client network nodes; and, (b) distributing the sorted prescription orders to the at least one pharmacy network node.

In some embodiments the workstation computer also includes computer readable program code means having instructions for transmitting at least one of the image file and the electronically captured information to the central office network node.

In some embodiments the workstation computer includes computer readable program code means having instructions for: determining if one or more new drug prescriptions are included in the electronically captured pen stroke information; generating a prescription order including the one or more new drug prescriptions; and transmitting the prescription order.

In some embodiments the at least one client network node also includes a Local Area Network (LAN) to which the workstation computer belongs, the LAN including other workstation computers each having computer readable program code means embodied thereon for (i) producing an image file, from electronically captured pen stroke information and the digital map pattern; and (ii) transmitting at least one of the image file and the electronically captured information to the central office network node.

In some embodiments the at least one client network node, the at least one pharmacy network node and the central office network node each include a respective connection to a data network, the data network including a suitable combination of at least one of a portion of a private intranet, the publicly accessible internet, switched telephone lines, Ethernet connections, ISDN lines, optical data-transport links, wireless data links, wireless cellular links and any suitable combination of the same and similar elements. In some more specific embodiments the drug prescription processing system also includes a respective plurality of network firewall gateways connectable between the data network and the at least one client network node, the at least one pharmacy network node and the central office network node, respectively. In some even more specific embodiments the at least one client network node also includes a fax machine connectable to the order server of the at least one pharmacy network node.

In some embodiments the order server also includes computer readable program code means having instructions for recreating image files, from information included within the prescription order, corresponding to respective forms written on at a health-care facility.

In some embodiments the at least one pharmacy network node also includes a Local Area Network (LAN) to which the order server belongs, the LAN also including: a database server for electronically storing the database; a storage server for electronically storing the image files; and a pharmacist station, including the user interface, through which a user can review information on at least on of the order server, the database server and the storage server. In some more specific embodiments the pharmacist station includes computer readable program code means having instructions for recreating image files, from information included within the prescription order, corresponding to respective forms written on at a health-care facility. In some even more specific embodiments the information received within a prescription order includes electronically captured pen stroke information and information about a digital map pattern.

Other aspects and features of the present invention will become apparent, to those ordinarily skilled in the art, upon review of the following description of the specific embodiments of the invention.

### BRIEF DESCRIPTION OF THE DRAWINGS

For a better understanding of the present invention, and to show more clearly how it may be carried into effect, reference will now be made, by way of example, to the accompanying drawings, which illustrate aspects of embodiments of the present invention and in which:

FIG. 1 is a diagram of a first electronic network for prescription order processing according to a first embodiment of the invention;

FIG. 2 is a more detailed diagram of one example data path included in the first electronic network of FIG. 1;

FIG. 3 is a diagram of a second electronic network for prescription order processing according to a second embodiment of the invention;

FIG. 4 is a schematic drawing of a third electronic network for prescription order processing according to a third embodiment of the invention;

FIG. 5 is a flow chart depicting the general steps of an electronically-aided method for processing prescription orders within an inpatient health-care facility according to an embodiment of the invention; and

FIG. 6 is a flow chart depicting the general steps of an electronically-aided method for processing prescription orders by an order server located at a central network node or a pharmacy according to an embodiment of the invention.

### DETAILED DESCRIPTION OF THE INVENTION

Human error, during the relaying of instructions from a doctor (working within an inpatient health-care facility) to a pharmacy, sometimes results in lost and/or incorrectly filled drug prescriptions. The errors are accidental and are made within the inpatient health-care facility and the pharmacy. Changing the operating procedures within an inpatient health-care facility and/or a pharmacy may inadvertently introduce new sources of liability. Subsequently, health-care professionals are naturally very cautious and risk averse when contemplating the adoption of new operating procedures and electronic systems that involve significant changes to their accepted procedures. Moreover, despite the sometimes poor-quality of fax transmission that adds to the number of errors made, fax transmission has traditionally been the only way to verify signatures required for drug dispensing.

Some embodiments of the invention provide an electronically-aided system and method for processing drug prescriptions in a manner that may reduce the number of lost and/or incorrectly filled drug prescriptions without disrupting existing operating procedures within a pharmacy or an inpatient health-care facility. In such embodiments, the potential for human error is reduced by reducing the number of times information is manually processed, handled and/or transcribed by individuals in the health-care staff. For example, within an inpatient health-care facility, nurses are no longer required to manually transcribe hand-written instructions provided by a doctor into a form suitable for fax transmission. In a related analogous example, within a pharmacy, a pharmacist or an assistant does not have to decipher and then manually enter information from received faxes into an electronically-stored database or paper-based file system. In contrast, according to some embodiments of the invention hand-written notes and instructions provided by a doctor are automatically and electronically captured by a digitally-enabled pen as the doctor writes. The respective electronically captured data can be processed into image files and sent to a pharmacy, thereby significantly reducing the number of times information is manually processed, handled and/or transcribed by individuals in the health-care staff.

Some embodiments of the invention employ the use of various forms (e.g. patient information forms and prescription forms) that include digital map patterns and digitally-enabled pens that can identify the digital map patterns and simultaneously collect pen stroke information as a user writes on such forms. Digital map patterns, such as those provided under the Anoto™ brand (http://www.anoto.com) are patterns that can be printed onto a sheet of paper before other information. Such digital map patterns typically appear to be a layer of faint dots that form a grid-like pattern that is not easily recognizable to the naked human eye. The arrangement of dots, in some instances, is specific to a sheet of paper or a number of sheets, thereby providing a means for identifying the sheet or sheets when scanned by a digitally-enabled pen. An optical sensor the digitally-enabled pen registers the pen's movement across a grid-like digital map pattern on a sheet and stores it as series of map coordinates. These coordinates correspond to the exact location on the sheet that is being written on.

Very specific embodiments of the invention incorporate the use of various forms (e.g. patient information forms and prescription forms) that include unique Anoto™ patterns and digitally-enabled pens that can identify Anoto™ patterns and simultaneously collect pen stroke information as a user writes on such forms. A commercially available example of such a digitally-enabled pen is the Logitech™ io2™ pen, which will be described in more detail below. Other digitally-enabled pen manufacturers include Nokia™, Sony™, and Maxwell™

Anoto™ patterns can be used to uniquely identify a form, and more specifically, a particular sheet of paper that a boilerplate form is printed on, thereby providing a means to identify a particular instance of a form from thousands of other forms identical to that form except for the respective Anoto™ pattern printed on the same sheet of paper. An Anoto™ pattern is almost invisible to the naked eye and a single 8.5″×11″ sheet of paper including an Anoto™ pattern actually only has a very small portion of a much larger composite Anoto™ pattern. The much larger composite Anoto™ pattern has the approximate equivalent area of the combined land area of Europe and Asia, in which each small portion can be uniquely identified. Given the immense number of available Anoto™ patterns, in very specific embodiments of the invention each sheet of paper within a respective health-care facility can have a unique Anoto™ pattern and thus be uniquely identifiable within that health-care facility. Alternatively and/or additionally, each sheet of paper within a respective number of health-care facilities can have a unique Anoto™ pattern and thus be uniquely identifiable within that respective number of health-care facilities. In such embodiments, it is beneficial that each of the respective number of health-care facilities is serviced by the same pharmacy service.

A digitally-enabled pen, included in embodiments of the invention, includes a traditional ink dispensing system (e.g. a ball-point, felt-tip or ink gel applicator) and an optical sensor system. The ink dispensing system allows the digitally-enabled pen to be used as a traditional pen for writing. As a user writes with the digitally-enabled pen the optical sensor system senses and stores information about an Anoto™ pattern included on a sheet of paper a form is printed on. Specifically, the optical sensor system recognizes unique Anoto™ patterns and electronically captures pen stroke information, relating to where on the sheet of paper the pen strokes are occurring, by using the Anoto™ pattern to gauge bearings. For example, the optical sensor system on the io2™ digitally-enabled pen, manufactured by Logitech™, is able to recognize unique Anoto™ patterns on respective sheets of paper and sort electronically captured pen stroke information by sheet provided that each sheet is provided with a unique Anoto™ pattern.

Using a particular Anoto™ pattern and raw data representing electronically captured pen stroke information, a respective image of a corresponding form and the hand-written markings on the form can be re-created electronically. The electronic images can be checked and then electronically transmitted to an order server accessible by a pharmacist. Alternatively and/or additionally, the raw data representing electronically captured pen stroke information is sent from an inpatient health-care facility to the order server. The order server electronically sorts and stores the electronic images and/or raw data into a corresponding pharmacy database. Some embodiments of the invention also provide a specific architecture to enable to rapid, reliable and transparent transfer of drug prescriptions and warnings from a health-care facility to a pharmacy.

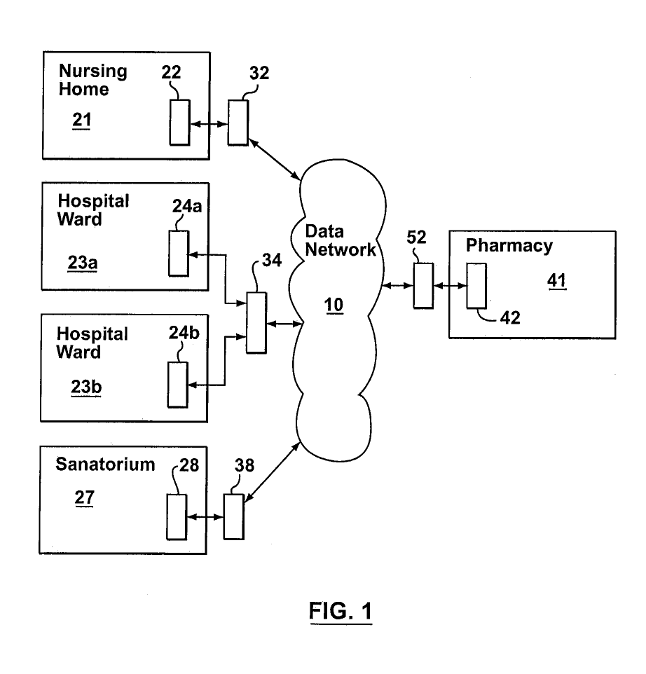

Referring to FIG. 1, shown is a diagram of an electronic network for prescription order processing provided in accordance with one very specific embodiment of the invention. The electronic network includes multiple points of access to a data network 10 through which data relating to prescription orders is communicated. In some embodiments the data network 10 includes at least one of a portion of a private intranet, the publicly accessible internet, switched telephone lines, Ethernet connections, ISDN lines, optical data-transport links, wireless data links, wireless cellular links and/or any suitable combination of the same and/or similar elements. The electronic network also includes a number of client network nodes, shown for example as client network nodes 22, 24a, 24b and 28, within respective client-locations and a centralized pharmacy network node 42 within a pharmacy 41.

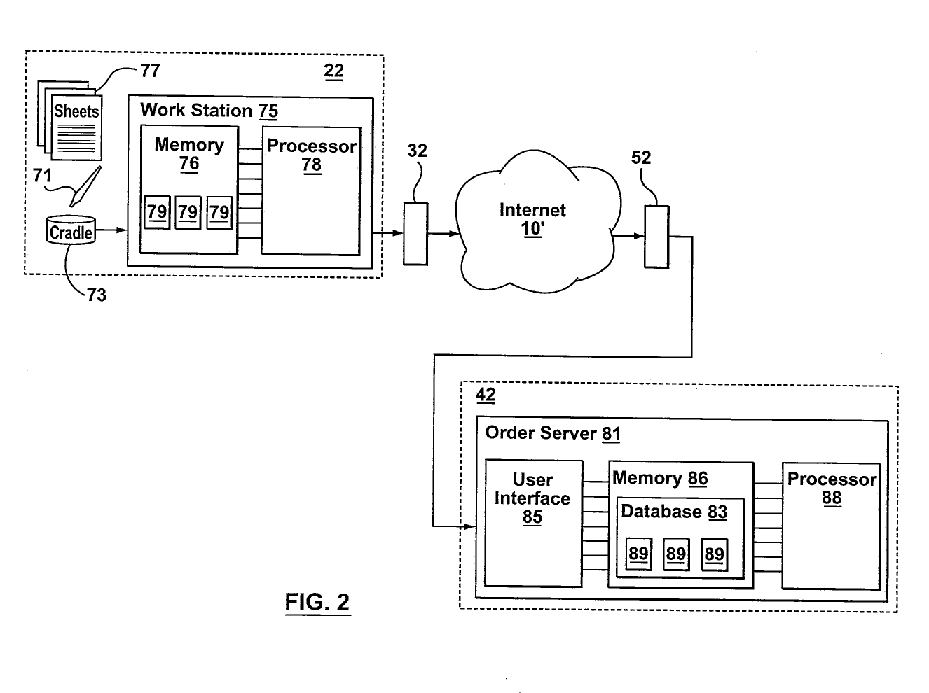

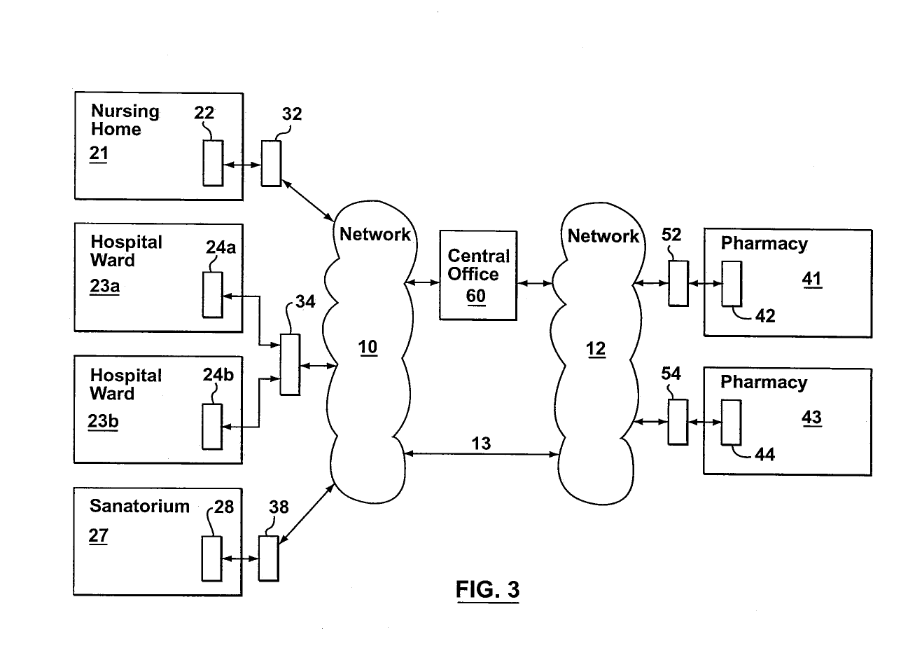

Specifically, as shown for example only, the client network nodes 22, 24a, 24b and 28 are located within a nursing home 21, hospital wards 23a and 23b and a sanatorium 27, respectively. Any number of client network nodes may be provided in the electronic network, yet only four have been shown for the sake of brevity. Each client network node 22, 24a, 24b and 28 serves as a local terminal for doctors and other health-care professionals to upload electronically captured information, representing pen strokes on forms including Anoto™ patterns, from digitally-enabled pens onto the electronic network at the health-care facility that they work within. In contrast to the numerous client network nodes 22, 24a, 24b and 28, only one centralized pharmacy network node 42 is provided in accordance with this particular embodiment. The pharmacy network node 42 coordinates the reception of all prescription orders originating from the client network nodes 22, 24a, 24b, and 28. A more specific description of the operation of the electronic network will be provided further below with added reference to FIG. 2. Alternatively and/or additionally, node 42 (or the like) can be embodied as one or more nodes at the same location handling orders/transactions for load balancing and redundancy. Moreover, in other embodiments, such as the one described below with reference to FIG. 3, nodes similar to node 42 can be hosted at different locations (e.g. geographically separated branch offices providing further redundancy and/or segregation of transactions for different regions).

Optionally, a level of network security can be provided within the electronic network shown in FIG. 1 by including network firewall gateways. As specifically illustrated in FIG. 1 for example only, network firewall gateways 32, 34, 38 and 52 are provided for corresponding client network nodes 22, 24a and 24b, 28 and the pharmacy network node 42, respectively. Of particular interest, the network client nodes 24a and 24b are connected to the network 10 through the single network firewall gateway 34, and are not individually provided with respective individual network firewall gateways. In some health-care facilities, such as in a hospital that has many wards, units and wings, it may be more cost effective to provide the entire health-care facility with a single network firewall gateway. However, in alternative embodiments, multiple network firewall gateways are included at a single health-care facility depending upon, without limitation, the level of network traffic expected, the desire to provide secure separation between wards, units and/or wings in the same facility and the cost of installing multiple network firewall gateways.

The network firewall gateways 32, 34, 38 and 52 serve to regulate the secure transmission of information/data between the client network nodes 22, 24a and 24b, 28 and the pharmacy network node 42 and to protect the corresponding client network nodes 22, 24a and 24b, 28 and the pharmacy network node 42 from hostile transmissions (e.g. computer viruses, worms, spyware, and the like) originating from the network 10. In some specific embodiments system specific header information is appended to data packets, frames and the like used in the transmission of information between the client network nodes 22, 24a and 24b, 28 and the pharmacy network node 42. Those skilled in the art will appreciate that there are various options for including network firewall gateways within an electronic network in order to securely transmit information between the nodes of the electronic network, and for the sake of brevity, such options will not be described in detail herein.

Referring to FIG. 2, and with further reference to FIG. 1, shown is a more detailed diagram of network elements included in the client network node 22 (located at the nursing home 21) and the pharmacy network node 42, and a data path between the two. The network 10 of FIG. 1 has been specifically replaced with the Internet 10′ in FIG. 2 in order to more specifically describe particular example. As is similarly shown in FIG. 1, the client network node 22 and the pharmacy network node 42 are connected to the internet 10′, and thus one another, via the network firewall gateways 32 and 52, respectively.

The client network node 22 includes a workstation computer 75 (e.g. a personal computer, network computer, etc.), a pen-cradle 73 and a digitally-enabled pen 71. A number of sheets 77, each having a respective unique Anoto™ pattern, are also included. The workstation computer 75 includes a processor 78 and a memory 76 that is accessible by the processor 78. Those skilled in the art will appreciate that the workstation computer 75 also includes an additional suitable combination of hardware, software and firmware, and that the functional elements illustrated in FIG. 2 have only been provided to describe aspects of a very specific embodiment of the invention.

In some embodiments, the digitally-enabled pen 71, the pen-cradle 73 and workstation computer 75 are each provided with a respective identification number that is preferably unique within the electronic network. As a result, a form can be given a page address that includes one or more of the identification numbers belonging to a particular digitally-enabled pen, a particular cradle and a particular workstation computer. Additionally and/or alternatively, in some embodiments, a page address may also include a reference tag specific to a particular Anoto™ pattern on a respective sheet of paper.

In some embodiments, in the event that the digitally-enabled pen 71 is lost or broken, a new one can be added to the system in place of the lost or broken digitally-enabled pen 71. However, as a precaution the replacement undergoes a verification/authentication process in which the identification number of the lost or broken digitally-enabled pen 71 is transferred to the replacement, and the lost or broken digitally-enabled pen 71 has its authorization to operate within the electronic network unconditionally revoked. Such strict precautions may reduce the instances of counterfeit digitally-enabled pens able to operate within the electronic network, and thereby reduce the number of fraudulent drug prescriptions originating from within the electronic network. Additionally and/or alternatively, a similar verification/authentication process can be implemented for other elements of the electronic system, such as for example, pen-cradles and workstation computers. Usage of the unique page addresses is described in greater detail below.

The pen-cradle 73 is one of many different interfaces that can be used to transfer data from the from the digitally-enabled pen 71 to the workstation computer 75. Alternatively and/or additionally, a digitally-enable pen and workstation computer may be configured with known technologies, such as Bluetooth wireless modems, to enable direct transfer of data between digitally-enabled pens and workstation computers without the use of a wired pen-cradle. Other connection means include Universal Serial Bus (USB) connections, Ethernet connections, other types of serial and/or parallel bus ports and the like.

Alternatives for the workstation computer include devices with a processor and a memory capable of relaying information over a communication link. Such devices include Personal Digital Assistants (PDAs), cell phones, notebook computers and the like.

The pharmacy network node 42 includes an order server 81 for receiving, sorting and storing received transmissions from the client network nodes 22, 24a, 24b and 28. The order server 81 includes an optional user interface 85, a processor 88 and a memory 86 that is accessible by the processor 88. Those skilled in the art will appreciate that the order server 81 also includes an additional suitable combination of hardware, software and firmware and that the functional elements illustrated in FIG. 2 have only been provided to describe aspects of a very specific embodiment of the invention.

In operation, doctors and other health-care professionals (e.g. nurse-practitioners, nurses, radiation therapists, etc.) can use the digitally-enabled pen 71 to hand-write notes, instructions, drug prescriptions and/or warnings on the sheets 77 before, during and after assessing patients. The sheets 77 include, without limitation, forms for drug prescriptions and/or warnings, medical history forms, wellness-assessment forms, discharge forms and the like. The common link between all of the sheets 77 is that each sheet has a unique Anoto™ pattern that can be used to identify a particular one of the sheets 77 used within the nursing home 21. As the digitally-enabled pen 71 is used to write on the sheets 77 pen stroke information corresponding to the writings on a particular one of the sheets 77 is electronically captured. The digitally-enabled pen 71 organizes and stores such information using the specific Anoto™ pattern included on each one of the sheets 77. Accordingly, a user can write on two or more separate sheets 77 and the digitally-enabled pen 71 will record and store the corresponding pen stroke information according to which sheet the pen stroke information belongs to, without having to cradle the digitally-enabled pen 71 between writing on different sheets.

At various times during the course of a shift, the doctor (or other health-care professional) will place the digitally-enabled pen 71 into the pen-cradle 73, thereby cradling the digitally-enabled pen 71. Each time the digitally-enable pen 71 is cradled, electronically captured pen stroke data and data relating to the detected Anoto™ patterns are uploaded from the digitally-enabled pen 71 to the workstation computer 75. Specifically, the data from the digitally-enabled pen 71 is stored in electronic files 79 within the memory 76. The electronic files 79 can include raw electronically captured data and/or other files, such as for example, image files recreated by the processor 78 from the raw electronically captured data. In any case, each of the files 79 corresponds to a respective one of the sheets 77 that can be uniquely identified by a particular Anoto™ pattern. Each of the files 79 can be further identified using the aforementioned format for page addresses, which includes at least one of the identification numbers of the digitally-enabled pen 71, the pen-cradle 73 and the workstation computer 75. For example, if the corresponding identification numbers of the aforementioned elements correspond to the reference numerals used in FIG. 2 a page address of one of the files 79 can be “75.73.71.nnn”, where the term “nnn” corresponds to the reference tag used for a particular Anoto™ pattern included on a respective one of the sheets 77. In this way, each one of the sheets 77 can be uniquely identified and have a respective unique electronic file 79 within the electronic system.

During the lifetime of the sheets 77, each one may be written on at different times. Accordingly, the respective electronic files 79 can be updated as new information is written/marked on the sheets 77. After subsequent updates, the digitally-enabled pen 71 is cradled and raw electronic data is uploaded as described above. The new electronic data is processed by the processor 78 and the respective files 79 are updated with the new information.

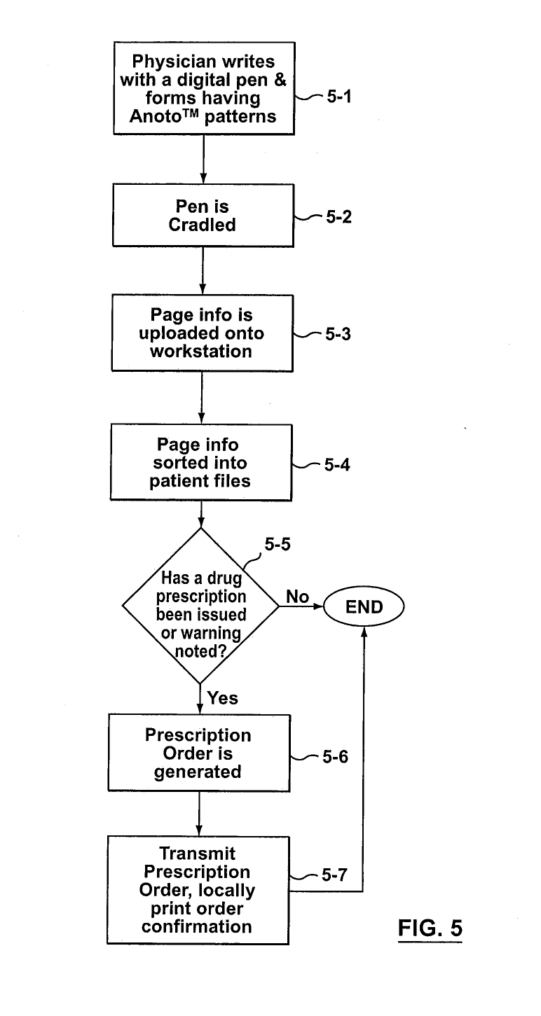

Nurses, doctors and/or other health-care professionals can double check the electronic files 79 that have been converted into image files corresponding to the sheets 77 to ensure that the correct information is present. Such information may include diagnosis information, new drug prescriptions and/or warnings. Once inspected copies of the electronic files 79 are transmitted over the Internet 10′ to the order server 81 in the pharmacy network node 42. Another detailed electronically-aided method of processing the sheets 77 within a client site is described below with reference to the flow chart shown in FIG. 5.

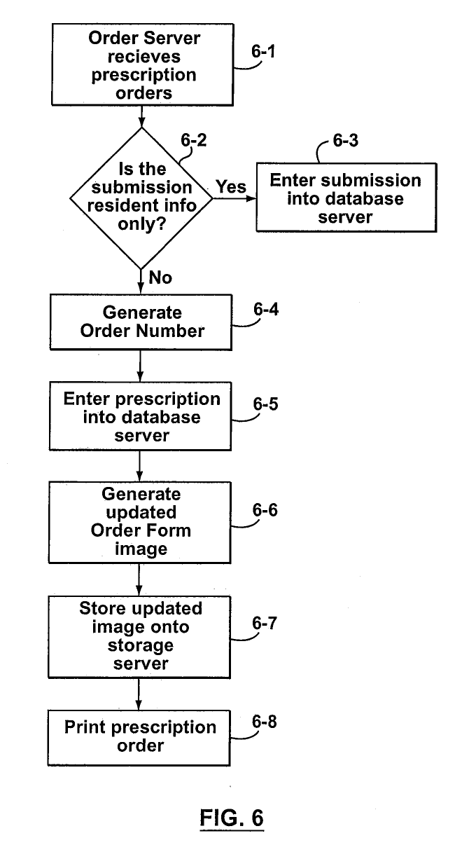

At the pharmacy, and specifically, within the order server 81, the received files are saved as electronic files 89 illustrated in FIG. 2. Specifically, the electronic files 89 are saved into the database 83 residing within the memory 86 of the order server 81. If the electronic files 89 are not image files, and instead include raw electronic data, the raw electronic data is first processed by the processor 88 to convert the raw electronic data into images, thereby recreating electronic copies of images of the sheets 77 located within the nursing home 21. In either case, the electronic files 89 are eventually converted into image files that can be reviewed by a pharmacist using the user interface 85. The pharmacist can then fill drug prescriptions accordingly. Another detailed electronically-aided method of processing the electronic files 89 within a pharmacy is described below with reference to the flow chart shown in FIG. 6.

Referring now to FIG. 3, shown is a diagram of a second electronic network for prescription order processing according to a second embodiment of the invention. The second electronic network illustrated in FIG. 3 is similar to the electronic network illustrated in FIG. 1, and accordingly, elements common to each are designated using the same reference numerals. For brevity, the description of FIG. 1 will not be repeated with respect to FIG. 3. In addition to the elements described with reference to FIG. 1, the second electronic network also includes a central office network node 60, a second data network 12, and another pharmacy 43. The pharmacy 43 includes a corresponding pharmacy network node 44 and a network firewall gateway 54 through which the pharmacy network node 44 securely communicates with other elements in the second electronic network. In some embodiments, the network firewall gateway 54 may not be provided.

The central office network node 60 is connected between the two data networks 10 and 12. The two data networks 10, 12 are also connected to one another via at least one data path, shown for example as data link 13. The pharmacy network node 42, located in the first pharmacy 41, is no longer directly coupled to the first data network 10, and is instead coupled to the second data network 12 via the network firewall gateway 42. Similarly, the pharmacy network node 44, located in the second pharmacy 43, is coupled to the second data network 12. In alternative embodiments, the pharmacy network nodes 42 and 44 may each be connected to one or both of the data networks 10 and 12. Moreover, although only two pharmacies 41 and 43, with corresponding pharmacy network nodes 42 and 44, are illustrated as a specific and non-limiting example, those skilled in the art will appreciate that any number of pharmacies, each with a respective pharmacy network node, may be provided in accordance with this embodiment of the invention.

In operation, hand-written notes, diagnosis information, medical-history updates, drug prescriptions and/or prescription warnings from doctors (or other health-care professionals) are electronically captured as described above with respect to FIGS. 1 and 2. Referring back to the second electronic system illustrated in FIG. 3, the difference embodied in the second electronic network is that prescription orders are not sent directly to a respective one of the two pharmacies 41, 43. By contrast, the prescription orders originating from the health-care facilities 21, 24a, 24b and 27 are routed through the central office network node 60 where each of the orders is catalogued and then assigned to one of the pharmacies 41 and 43 to be filled. The central office network node 60 assigns the prescription orders based on, without limitation, the ability of a particular pharmacy to effectively and timely fill an order, the geographic location of each pharmacy relative to where the order was received from, available stock of a prescribed drug at a particular pharmacy, feedback from the healthcare facility, etc.

Additionally, once a prescription order from one of the health-care facilities 21, 24a, 24b and 27 has been assigned to one of the pharmacies 41 and 43, the pharmacy and health-care facility may communicate via the data networks 10, 12 and the data link 13. Such communication may be useful for, without limitation, the transfer of additional patient information, feedback from the pharmacy, etc.

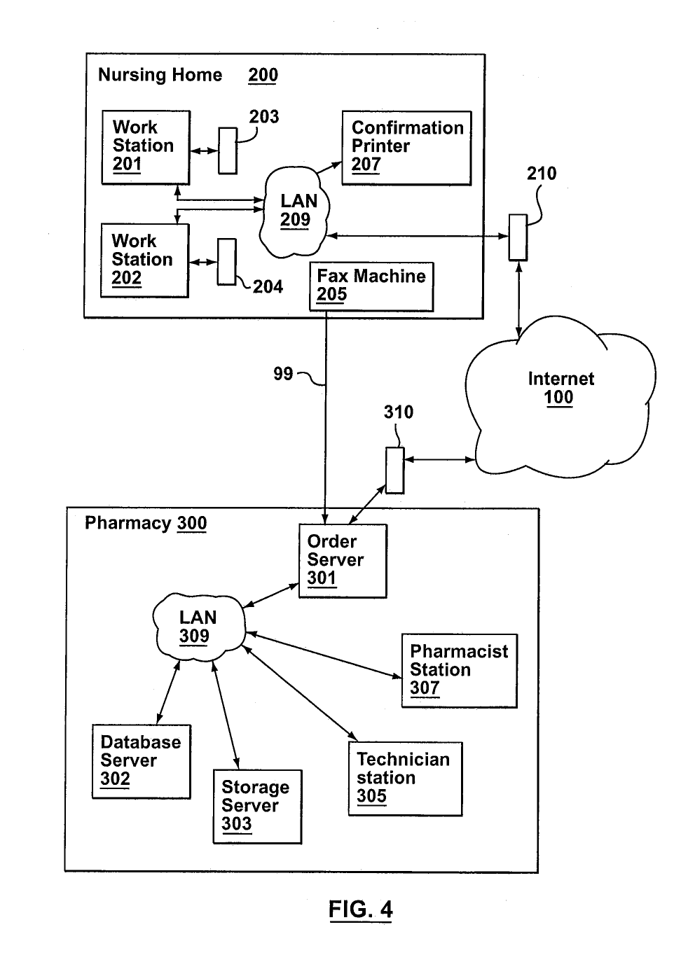

Referring now to FIG. 4, shown is a schematic drawing of a third electronic network for prescription order processing according to a third embodiment of the invention. The third electronic network illustrated in FIG. 4 includes a nursing home 200, a pharmacy 300, data paths through the Internet 100 and a fax transmission line 99 (e.g. a publicly switched telephone line). Although only a single health-care facility and a single pharmacy are illustrated in FIG. 4, those skilled in the art will appreciate that any number of health-care facilities and pharmacies may be included in similar embodiments. Only the nursing home 200 and the pharmacy 300 have been illustrated in FIG. 4 for the sake of brevity and clarity in order to describe this very specific embodiment according to the invention.

With continued reference to FIG. 4, the nursing home 200 includes a Local Area Network 209. Specific elements of the LAN 209, illustrated in FIG. 4, include a fax machine 205, a confirmation printer 207, workstation computers 201, 202 and pen-cradles 203, 204 that are coupled to the corresponding workstation computers 201, 202, respectively. A network firewall gateway 210 is also provided and coupled to the LAN 209, thereby securely connecting the nursing home 200 to the Internet 100. Those skilled in the art will appreciate that the LAN 209 may also include an additional suitable combination of hardware, firmware and software in addition to a suitable combination of routers, switches, hubs, other workstation computers, printers and the like, and only those elements necessary to describe this embodiment according to the invention have been illustrated in FIG. 4.

The pharmacy 300 also includes LAN 309. Specific elements of the LAN 309, illustrated in FIG. 4, include an order server 301, a database server 302, a storage server 303, a technician station 305 and a pharmacist station 307. A network firewall gateway 310 is also provided and coupled to the LAN 309, thereby securely connecting the pharmacy 300 to the Internet 100 and thus the nursing home 200. The fax machine 205, within the nursing home, is also connected to the order server 301 via the fax transmission line 99, which thereby serves as a fax-based backup data-path between the nursing home 200 and the pharmacy 300.

In operation, hand-written notes, diagnosis information, medical-history updates, drug prescriptions and/or prescription warnings from doctors (or other health-care professionals) are electronically captured as described above with respect to FIGS. 1 and 2. With specific reference to the elements illustrated in FIG. 4, doctors (or other health-care professionals) may cradle their digitally-enabled pens (not shown) within the pen-cradles 203 and 204, and subsequently upload raw electronically captured information on the respective workstation computers 201 and 202, respectively. Nurses, doctors and/or other members of the staff may check corresponding images created from the raw electronically captured data before electronically transmitting either the raw electronically captured data and/or the corresponding image files to the pharmacy 300 via the Internet 100. Copies of prescription orders sent to the pharmacy 300 can be automatically printed by the confirmation printer 207 with each transmission and/or manually printed (and then re-printed) using the confirmation printer 207 as desired. Additionally, in the event that the connection to the Internet 100 from the nursing home 200 is unavailable, prescription orders can be faxed directly to the pharmacy 300 using the fax machine 205.

Within the pharmacy 300, prescription orders, sent via the internet 100 or the fax transmission line 99, are received by the order server 301. As will be described in greater detail below, with reference to FIG. 6, prescription orders are automatically and electronically parsed, entered into the database server 302 and stored on the storage server 303. Pharmacists and/or technicians can access information from the order server 301, the database server 302 and the storage server 303 through the pharmacist station 307 and the technician station 305, respectively. Accordingly, drug prescriptions and medical history information sent with prescription orders is now electronically accessible to the pharmacist and/or technicians as required so that drug prescriptions can be filled and doubled-checked before they are sent back to the nursing home 200.

A flow chart depicting the general steps of an electronically-aided method for processing prescription orders within an inpatient health-care facility according to an embodiment of the invention is illustrated in FIG. 5. Such inpatient health-care facilities include, for example and without limitation, nursing homes, hospitals, sanatoriums, drug rehabilitation centers, a doctor's office and the like. Starting at step 5-1, within such a facility, a physician (or another health-care professional) hand writes notes, drug prescriptions and the like onto forms having Anoto™ patterns with a digitally-enabled pen. At step 5-2, the digitally-enabled pen is placed into a pen-cradle, thereby cradling the digitally-enabled pen, and raw electronically captured information is uploaded from the pen onto a workstation computer via the pen-cradle at step 5-3. Alternatively the raw electronically captured information is uploaded from the digitally-enabled pen to the workstation computer via another connection means, as described above. At step 5-4, the raw electronically captured data is then sorted and stored into patient files.

At step 5-5, it is determined whether or not a drug prescription has been issued or a warning relevant to a pharmacist has been noted in the electronically captured data. If a drug prescription has not been issued and a warning relevant to a pharmacist has not been noted (no path, step 5-5), then the method ends. On the other hand, if a drug prescription has been issued or a warning relevant to a pharmacist has been noted in the electronically captured data (yes path, step 5-5), then a prescription order is generated, containing such information, at step 5-6. Subsequently, at step 5-7, the prescription order is transmitted away from the inpatient health-care facility and printed locally within the inpatient health-care facility. In some embodiments, steps 5-5, 5-6 and 5-7 are carried out on a per patient file basis. In alternative embodiments, the prescription orders for multiple patients are transmitted collectively.

An order server, that is located within a central office network node and/or a pharmacy, eventually receives the transmissions from the inpatient health-care facility. FIG. 6 is a flow chart depicting the general steps of an electronically-aided method for processing prescription orders within a central office network node and/or pharmacy according to an embodiment of the invention.

Starting with step 6-1, the order server receives one or more prescription orders. At step 6-2, it is determined whether or not each prescription order contains only resident (i.e. patient) information, thereby only providing useful information but not requesting that a new drug prescription be filled. If the prescription order contains only resident information (yes path, step 6-2), then the submission is entered into a database server. On the other hand, if a new drug prescription has been submitted (no path, step 6-2), an order number is generated at step 6-4 and the prescription is entered into the database server at step 6-5. Subsequently, at step 6-6 a new electronic image file of the corresponding order form is generated and stored in a storage server at step 6-7. At step 6-8 the prescription order is printed for a pharmacist to review and fill.

While the above description provides example embodiments, it will be appreciated that the present invention is susceptible to modification and change without departing from the fair meaning and scope of the accompanying claims. Accordingly, what has been described is merely illustrative of the application of aspects of embodiments of the invention. Numerous modifications and variations of the present invention are possible in light of the above teachings. It is therefore to be understood that within the scope of the appended claims, the invention may be practiced otherwise than as specifically described herein.

We claim:

1. A client network node for drug prescription processing within a health-care facility comprising:
a digitally-enabled pen having an ink dispensing system for dispensing ink onto a form, and an optical sensor system for recognizing a digital map pattern on the same form and electronically capturing pen stroke information while the digitally-enabled pen is used to write on the form;
a workstation computer having a memory and a processor, the processor having computer readable program code means embodied thereon for (i) producing an image file, from electronically captured pen stroke information and the digital map pattern, corresponding to the form used in the health-care facility; and (ii) transmitting at least one of the image file and the electronically captured pen stroke information; and
a means of transferring electronically captured pen stroke information from the digitally-enabled pen into the memory.

2. A client network node according to claim 1, wherein the digital map pattern is an Anoto™ pattern.

3. A client network node according to claim 1, wherein the means of transferring electronically captured pen stroke information from the digitally-enabled pen into the memory is a pen-cradle, connectable to the workstation computer, into which the digitally-enabled pen can be placed.

4. A client network node according to claim 1, wherein the means of transferring electronically captured pen stroke information from the digitally-enabled pen into the memory includes at least one of a Bluetooth wireless modem, an Ethernet connection and a Universal Serial Bus (USB) connection.

5. A client network node according to claim 1, wherein the workstation computer includes computer readable program code means having instructions for:
determining if one or more new drug prescriptions are included in the electronically captured pen stroke information;
generating a prescription order including the one or more new drug prescriptions; and
transmitting the prescription order.

6. A client network node according to claim 5, wherein the workstation computer also includes computer readable program code means having instructions for printing the prescription order at the health-care facility.

7. A client network node according to claim 1 further comprising a Local Area Network (LAN) to which the workstation computer belongs, the LAN including other workstation computers also having respective memory and processors, each respective processor having computer readable program code means embodied thereon for (i) producing an image file, from electronically captured pen stroke information and a digital map pattern; and (ii) transmitting at least one of the image file and the electronically captured pen stroke information.

8. A client network node according to claim 1 further comprising a connection to a data network, the data network including a suitable combination of at least one of a portion of a private intranet, the publicly accessible internet, switched telephone lines, Ethernet connections, ISDN lines, optical data-transport links, wireless data links and any combination of the same and similar elements.

9. A client network node according to claim 8 further comprising a network firewall gateway connectable between the workstation computer and the data network.

10. A client network node according to claim 8 further comprising a fax machine serving as a fax-based backup to the data network.

11. A pharmacy network node for processing drug prescription orders received from a health-care facility comprising:
a database for storing received drug prescriptions;
an order server externally connectable to a data network for electronically receiving a prescription order, the order server includes computer readable program code means having instructions for (i) parsing the prescription order to determine if one or more new drug prescriptions are included in the prescription order; and (ii) entering the one or more new drug prescriptions into database; and
a user interface for accessing information on at least one of the order server and database.

12. A pharmacy network node according to claim 11, wherein the order server also includes computer readable program code means having instructions for recreating image files, from information included within the prescription order, corresponding to respective forms written on at a health-care facility.

13. A pharmacy network node according to claim 12 further comprising a Local Area Network (LAN) to which the order server belongs, the LAN also including:
a database server for electronically storing the database;
a storage server for electronically storing the image files; and
a pharmacist station, including the user interface, through which a user can review information on at least one of the order server, the database server and the storage server.

14. A pharmacy network node according to claim 13, wherein the LAN also includes a technician station, including another user interface, through which a user can review information on at least one of the order server, the database server and the storage server.

15. A pharmacy network node according to claim 13, wherein the pharmacist station includes computer readable program code means having instructions for recreating image files, from information included within the prescription order, corresponding to respective forms written on at a health-care facility.

16. A pharmacy network node according to claim 13 wherein some of the information included within a prescription order is electronically captured pen stroke information and information about a digital map pattern.

17. A pharmacy network node according to claim 12 further comprising a connection to a data network, the data network including a suitable combination of at least one of a portion of a private intranet, the publicly accessible internet, switched telephone lines, Ethernet connections, ISDN lines, optical data-transport links, wireless data links and any suitable combination of the same and similar elements.

18. A pharmacy network node according to claim 17 further comprising a network firewall gateway connectable between the order server and the data network.

19. A pharmacy network node according to claim 17, wherein the order server further comprises a connection to a fax transmission line, the fax-transmission line serving as a fax-based backup to the data network.

20. A drug prescription processing system comprising:
at least one client network node including (i) a digitally-enabled pen for writing on a form, for recognizing a digital map pattern on the same form and electronically capturing pen stroke information while the digitally-enabled pen is used to write on the form; and (ii) a workstation computer having computer readable program code means embodied thereon for producing an image file from electronically captured pen stroke information and the digital map pattern;
at least one pharmacy network node including an order server for electronically receiving a prescription order, and a user interface for accessing information on the order server; and
a central office network node, connectable between each of the at least one client network nodes and each of the at least one pharmacy network nodes, the central office network node having computer readable program code means embodied thereon for (a) sorting prescription orders from each of the at least one client network nodes; and, (b) distributing the sorted prescription orders to the at least one pharmacy network node.

21. A drug prescription processing system according to claim 20, wherein the workstation computer also includes computer readable program code means having instructions for transmitting at least one of the image file and the electronically captured information to the central office network node.

22. A drug prescription processing system according to claim 20, wherein the workstation computer includes computer readable program code means having instructions for:
determining if one or more new drug prescriptions are included in the electronically captured pen stroke information;
generating a prescription order including the one or more new drug prescriptions; and
transmitting the prescription order.

23. A drug prescription processing system according to claim 20, wherein the at least one client network node further comprises a Local Area Network (LAN) to which the workstation computer belongs, the LAN including other workstation computers each having computer readable program code means embodied thereon for (i) producing an image file, from electronically captured pen stroke information and the digital map pattern; and (ii) transmitting at least one of the image file and the electronically captured information to the central office network node.

24. A drug prescription processing system according to claim 20, wherein the at least one client network node, the at least one pharmacy network node and the central office network node each include a respective connection to a data network, the data network including a suitable combination of at least one of a portion of a private intranet, the publicly accessible internet, switched telephone lines, Ethernet connections, ISDN lines, optical data-transport links, wireless data links, wireless cellular links and any suitable combination of the same and similar elements.

25. A drug prescription processing system according to claim 24, further comprising a respective plurality of network firewall gateways connectable between the data network and the at least one client network node, the at least one pharmacy network node and the central office network node, respectively.

26. A drug prescription processing system according to claim 24, wherein the at least one client network node also includes a fax machine connectable to the order server of the at least one pharmacy network node.

27. A drug prescription processing system according to claim 20, wherein the order server also includes computer readable program code means having instructions for recreating image files, from information included within the prescription order, corresponding to respective forms written on at a health-care facility.

28. A drug prescription processing system according to claim 20, wherein the at least one pharmacy network node also includes a Local Area Network (LAN) to which the order server belongs, the LAN also including:
a database server for electronically storing the database;
a storage server for electronically storing the image files; and
a pharmacist station, including the user interface, through which a user can review information on at least on of the order server, the database server and the storage server.

29. A drug prescription processing system according to claim 28, wherein the pharmacist station includes computer readable program code means having instructions for recreating image files, from information included within the prescription order, corresponding to respective forms written on at a health-care facility.

30. A drug prescription processing system according to claim 29, wherein the information received within a prescription order includes electronically captured pen stroke information and information about a digital map pattern.
